(19) United States
(12) Patent Application Publication
(10) Pub. No.: US 2012/0144218 A1
(43) Pub. Date: Jun. 7, 2012

(54) Transferring Power and Speed from a Lock Requester to a Lock Holder on a System with Multiple Processors

(75) Inventors: Thomas M. Brey, Cary, NC (US); Freeman L. Rawson, III, Austin, TX (US)

(73) Assignee: INTERNATIONAL BUSINESS MACHINES CORPORATION, Armonk, NY (US)

(21) Appl. No.: 12/959,804

(22) Filed: Dec. 3, 2010

(51) Int. Cl. G06F 1/32; G06F 1/26

(52) U.S. Cl. 713/322; 713/300

(57) ABSTRACT

Power is allocated between processors in a multiprocessor system. A request to acquire a lock is received from a first thread executing on a first processor. Responsive to receiving the request to acquire a lock, determination is made as to whether a second thread has acquired the lock. Responsive to determining that the second thread has acquired the lock, an original frequency of the first thread executing on the first processor and an operating frequency of the second thread executing on the second processor is identified. The operating frequency of the second thread executing on the second processor is then altered based on the original frequency of the first thread executing on the first processor. When the second thread releases the lock, the spinning thread with the highest original frequency acquires the lock.

### BACKGROUND

1. Field

The disclosure relates generally to a computer implemented method, a computer program product, and a data processing system. More specifically, the disclosure relates to a computer implemented method, a computer program product, and a data processing system for dynamically reallocating power between processors of a multiprocessor system.

2. Description of the Related Art

To optimize system power and performance as well as to maintain safe operation under a power cap, systems architects and designers are beginning to implement computing systems on which the processors in a symmetric multiprocessor (SMP) system run at very different underlying speeds or frequencies and can dynamically change from one frequency setting to another, depending on power and performance considerations. Symmetric multiprocessor (SMP) system operating systems and hypervisors typically contain locks, usually implemented at least in part by spinning mechanisms, to protect critical sections of code and shared data from corruption. All such locks are coded based on some implicit assumptions about the nature and behavior of the machine. In particular, one standard assumption is that the processors of a symmetric multiprocessor (SMP) system run at approximately the same speed. This means that the holder of a lock makes progress at about the same rate that a requester spins for it. This determines expected lock hold time and contention level. However, the introduction of aggressive power management causes systems to run different processors at different frequencies, depending on policy and operating conditions. Processors may also change frequencies in response to power and performance considerations.

### SUMMARY

According to one embodiment of the present invention, a computer implemented method allocates power between processors in a multiprocessor system. A request to acquire a lock is received from a first thread executing on a first processor. Responsive to receiving the request to acquire a lock, a determination is made as to whether a second thread has acquired the lock. Responsive to determining that the second thread has acquired the lock, an original frequency of the first thread executing on the first processor and identifying an operating frequency of the second thread executing on the second processor is identified. The operating frequency of the second thread executing on the second processor is then altered based on the original frequency of the first thread executing on the first processor. When the second thread releases the lock, the spinning thread with the highest original frequency acquires the lock.

### BRIEF DESCRIPTION OF THE SEVERAL VIEWS OF THE DRAWINGS

FIG. 1 is a block diagram of a data processing system in which illustrative embodiments may be implemented;

FIG. 2 is a dataflow diagram for dynamically reallocating power between processors of a multiprocessor system according to an illustrative embodiment;

FIG. 3 is a dataflow for lock acquisition by a first thread within a multiprocessor system according to an illustrative embodiment;

FIG. 4 is a first dataflow for lock acquisition by a second thread operating at a lower frequency within a multiprocessor system according to an illustrative embodiment;

FIG. 5 is a series of frequency tracking data structures for tracking frequencies of a plurality of processors executing threads requesting access to a lock according to one illustrative embodiment;

FIG. 6 is a series of frequency tracking data structures for tracking frequencies of a plurality of processors executing threads requesting access to a lock according to one illustrative embodiment;

FIG. 7 is a series of frequency tracking data structures for tracking frequencies of a plurality of processors executing threads requesting access to a lock according to one illustrative embodiment;

FIG. 8 is a flowchart for dynamically reallocating power between processors of a multiprocessor system when a lock is requested according to an illustrative embodiment; and

FIG. 9 is a flowchart for dynamically reallocating power between processors of a multiprocessor system when a lock is released according to an illustrative embodiment.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

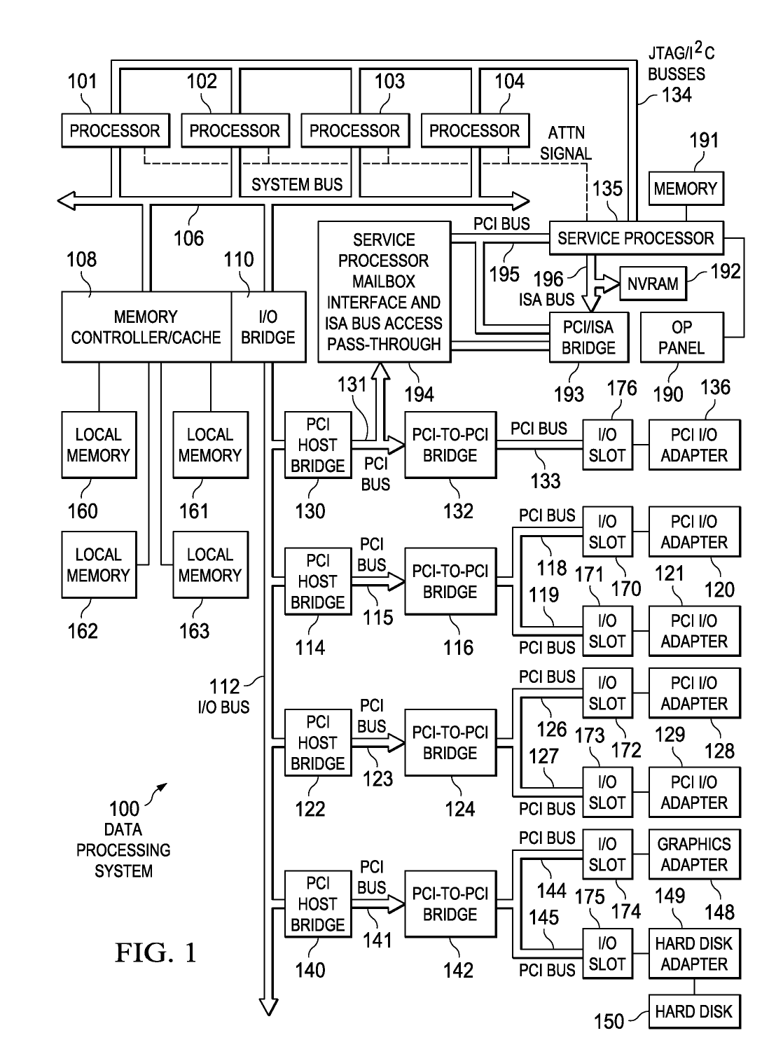

With reference now to the figures, and, in particular, with reference to FIG. 1, a block diagram of a data processing system in which illustrative embodiments may be implemented is depicted. Data processing system 100 may be a symmetric multiprocessor (SMP) system including processors 101, 102, 103, and 104, which connect to system bus 106. For example, data processing system 100 may be an IBM server system, a product of International Business Machines Corporation in Armonk, N.Y., used within a network. Alternatively, a single processor system may be employed. Also connected to system bus 106 is memory controller/cache 108, which provides an interface to local memories 160, 161, 162, and 163. I/O bridge 110 connects to system bus 106 and provides an interface to I/O bus 112. Memory controller/cache 108 and I/O bridge 110 may be integrated as depicted.

Peripheral component interconnect (PCI) host bridge 114 connected to I/O bus 112 provides an interface to PCI local bus 115. PCI I/O adapters 120 and 121 connect to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 connects to a plurality of PCI I/O adapters 128 and 129. PCI I/O adapters 128 and 129 connect to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers.

A memory mapped graphics adapter 148 is inserted into I/O slot 174 and connects to I/O bus 112 through PCI bus 144, PCI-to-PCI bridge 142, PCI bus 141, and PCI host bridge 140. Hard disk adapter 149 may be placed into I/O slot 175, which connects to PCI bus 145. In turn, this bus connects to PCI-to-PCI bridge 142, which connects to PCI host bridge 140 by PCI bus 141.

A PCI host bridge 130 provides an interface for PCI bus 131 to connect to I/O bus 112. PCI I/O adapter 136 connects to I/O slot 176, which connects to PCI-to-PCI bridge 132 by PCI bus 133. PCI-to-PCI bridge 132 connects to PCI bus 131. This PCI bus also connects PCI host bridge 130 to the service processor mailbox interface and ISA bus access pass-through 194 and PCI-to-PCI bridge 132. Service processor mailbox interface and ISA bus access pass-through 194 forwards PCI accesses destined to the PCI/ISA bridge 193. NVRAM storage 192 connects to the ISA bus 196. Service processor 135 connects to service processor mailbox interface and ISA bus access passthrough logic 194 through its local PCI bus 195. Service processor 135 also connects to processors 101, 102, 103, and 104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 connect together to an interrupt input signal of service processor 135. Service processor 135 has its own local memory 191 and has access to the hardware OP-panel 190.

When data processing system 100 is initially powered up, service processor 135 uses the JTAG/I²C busses 134 to interrogate the system (host) processors 101, 102, 103, and 104, memory controller/cache 108, and I/O bridge 110. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101, 102, 103, and 104, memory controller/cache 108, and I/O bridge 110. Any error information for failures detected during the BISTs, BATs, and memory tests are gathered and reported by service processor 135.

If a meaningful and valid configuration of system resources is still possible after taking out the elements found to be faulty during the BISTs, BATs, and memory tests, then data processing system 100 is allowed to proceed to load executable code into local (host) memories 160, 161, 162, and 163. Service processor 135 then releases host processors 101, 102, 103, and 104 for execution of the code loaded into local memory 160, 161, 162, and 163. While host processors 101, 102, 103, and 104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101, 102, 103, and 104, local memories 160, 161, 162, and 163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for de-configuration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM POWER Family Model 770 system available from International Business Machines Corporation. Such a system may run a hypervisor to partition the machine and then run multiple operating systems, one per partition, or alternatively, it may run an operating directly on the hardware without using a hypervisor.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to illustrative embodiments.

When a power-managed system with multiple processors running at different speeds runs a symmetric multiprocessor (SMP) system operating system or hypervisor, it may well be the case that the holder of a lock is running at lower frequency (or raw speed) than the waiter or waiters. When this happens, the implicit locking assumptions of the system may be violated, leading to poor performance, limited scalability, unexpected time-outs, and even system failures.

The illustrative embodiments herein provide a computer implemented method for allocating power between processors in a multiprocessor system. A request to acquire a lock is received from a first thread executing on a first processor. Responsive to receiving the request to acquire a lock, a determination is made as to whether a second thread has acquired the lock. Responsive to determining that the second thread has acquired the lock, an original frequency of the first thread executing on the first processor and identifying an operating frequency of the second thread executing on the second processor is identified. The operating frequency of the second thread executing on the second processor is then altered based on the original frequency of the first thread executing on the first processor.

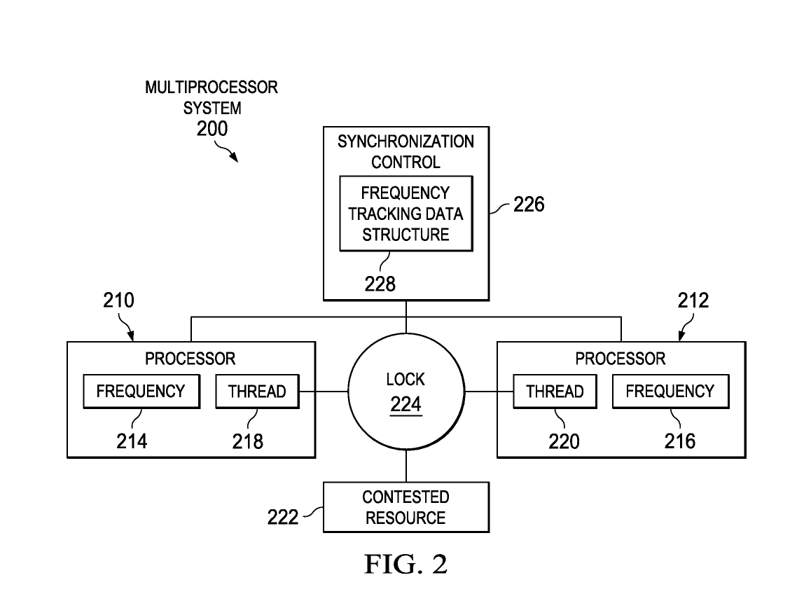

Referring now to FIG. 2, a dataflow diagram for dynamically reallocating power between processors of a multiprocessor system is shown according to an illustrative embodiment. Multiprocessor system 200 can be a multiprocessor system such as data processing system 100 of FIG. 1.

Multiprocessor system 200 includes a set of processors. The set of processors includes at least two processors, processor 210 and processor 212. The set of processors of multiprocessor system 200 is shown having only two processors, such is for simplicity only. The set of processors of Multiprocessor system 200 may include additional processors. Each of processor 210 and processor 212 is a processor such as one of processors 101, 102, 103, and 104 of FIG. 1.

Processor 210 operates at frequency 214. Processor 212 operates at frequency 216. Frequency 214 is the operating speed of processor 210 as measured in cycles per second. Frequency 214 is therefore the rate at which processor 210 can complete a processing cycle. Similarly, frequency 216 is the operating speed of processor 212 as measured in cycles per second. Frequency 216 is therefore the rate at which processor 212 can complete a processing cycle.

Processor 210 executes one or more threads, such as thread 218. Similarly, processor 212 executes one or more threads, such as thread 220. Each of thread 218 and thread 220 is a unit of processing that can be scheduled to one of processor 210 or processor 212 by an operating system. Each of thread 218 and thread 220 is a sequence of code. This code is often responsible for one aspect of a program, or one task the program has been given.

Multiprocessor system 200 includes contested resource 222. Contested resource 222 is data or some portion of a program that is required by both thread 218 and thread 220.

In order to maintain process synchronization, multiprocessor system 200 includes lock 224. Lock 224 is a synchronization mechanism for enforcing limits on access to contested resource 222. Lock 224 ensures that thread 218 and thread 220 do not concurrently attempt to execute contested resource 222. If thread 218 is executing contested resource 222, thread 220 must wait until thread 218 finishes before thread 220 is able to access contested resource 222. Conversely, if thread 220 is executing contested resource 222, thread 218 must wait until thread 220 finishes before thread 218 is able to access contested resource 222. In one illustrative embodiment, lock 224 may be implemented as part of synchronization control 226.

In one illustrative embodiment, lock 224 is a spinlock. A spinlock is a lock where a thread wanting to access a contested resource simply waits in a loop repeatedly checking until the lock becomes available. Once the lock is available, the thread is able to access the contested resource. As the waiting thread “spins,” it remains active, but does not perform any task other than waiting on another thread to release the lock.

Spinlocks are coded based on implicit assumptions about the nature and behavior of the machine. In particular, one standard assumption is that the processors of a symmetric multiprocessor (SMP) operate at approximately the same frequency. This assumption means that the holder of a lock makes progress at about the same rate that a requester “spins” for it. Therefore, the assumption regarding processor frequency determines expected lock hold time and contention level. However, the introduction of aggressive power management causes systems to run different processors at different frequencies, depending on policy and operating conditions. Processors may also change frequencies in response to power and performance considerations.

When a power-managed system with multiple processors running at different speeds runs a symmetric multiprocessor (SMP) operating system or hypervisor, it may well be the case that a processor, such as processor 210, holding a lock, such as lock 224, is running at a lower frequency (or raw speed) than a waiting processor, such as processor 212. When this happens, the implicit locking assumptions of the system may be violated, leading to poor performance, limited scalability, unexpected time-outs, and even system failures.

Idealized power consumption of a complementary metal-oxide-semiconductor (CMOS) circuit is given by the equation:

P=C*V²*F

wherein:

P is power;

C is the capacitance being switched per clock cycle;

V is voltage, and

F is the processor frequency (cycles per second).

Power consumption for a processor, such as processor 210 and processor 212, is more nearly a linear function of frequency. However, under idealized power conditions or otherwise, frequency and voltage scaling is the primary means of controlling the power consumption of a running processor.

Increases in frequency of the processor thus increases the amount of power used by that processor. Thus, the power that a processor uses can be manipulated by altering the frequency at which the processor operates. Power used by processor 210 can therefore be manipulated by altering frequency 214. Similarly, power used by processor 212 can be manipulated by altering frequency 216.

The illustrative embodiments remedy this problem by transferring frequency and power from a processor waiting for a lock, such as processor 212, to a processor that is currently holding a lock, such as processor 210. This frequency transfer allows the thread holding the lock to run relatively faster, reducing the lock hold time. This frequency transfer also saves wasted power by reducing the power consumption of the processors waiting for the lock.

Synchronization control 226 is software that controls access by thread 218 and thread 220 to lock 224. Thread 218 and thread 220 must acquire lock 224 before either of thread 218 and thread 220 can access contested resource 222. In a multiprocessor system, such as multiprocessor system 200, synchronization control 226 may be, for example, an operating system, or alternatively a hypervisor.

Synchronization control 226 includes frequency tracking data structure 228. Frequency tracking data structure 228 is a data structure that tracks the current operating frequencies, such as frequency 214 and frequency 216, for the processors of multiprocessor system 200, such as processor 210 and processor 212.

In one illustrative embodiment, frequency 214 and frequency 216 can be obtained by reading the hardware state of the system. However, even where frequency 214 and frequency 216 are obtained from the hardware state, frequency tracking data structure 228 is still required for proper behavior of the system when a processor holding lock 224, such as processor 210, later releases lock 224.

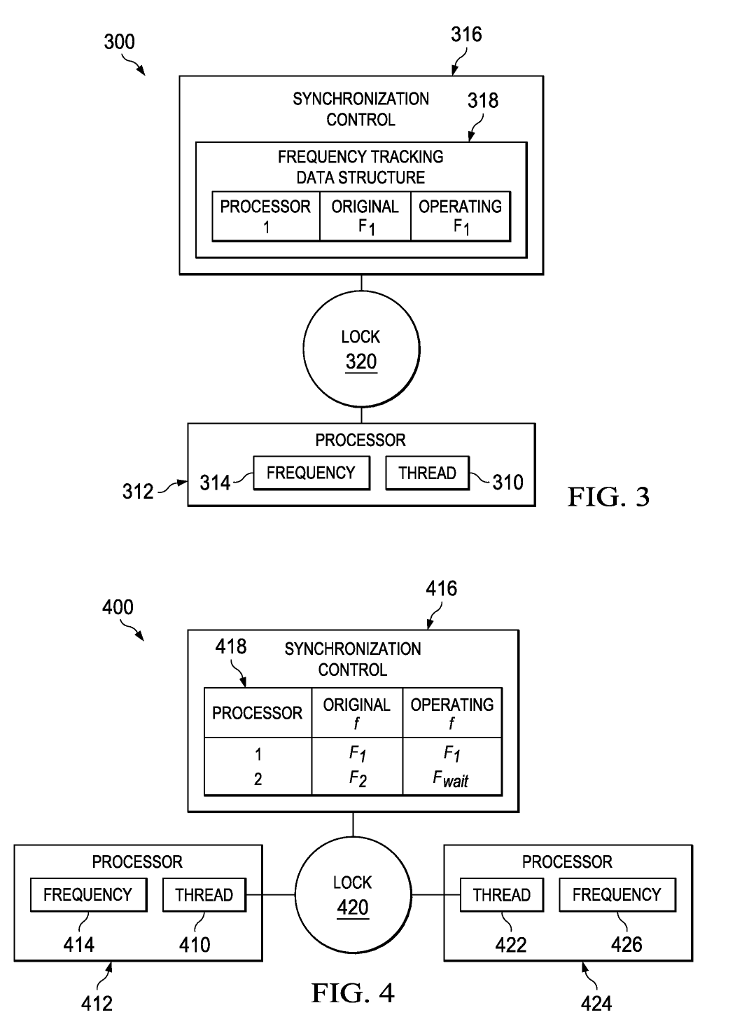

Referring now to FIG. 3, a dataflow for lock acquisition by a first thread within a multiprocessor system is shown according to an illustrative embodiment. Multiprocessor system 300 is a multiprocessor system, such as multiprocessor system 200 of FIG. 2.

Thread 310 executes on processor 312. Processor 312 operates at frequency 314. Frequency 314 is originally set to F₁. Synchronization control 316 tracks frequency 314 of processor 312 in frequency tracking data structure 318.

When thread 310 seeks to acquire lock 320 for access to a contested resource, such as contested resource 222 of FIG. 2, synchronization control 316 determines whether another thread is currently holding lock 320. Here, lock 320 is free; thus synchronization control 316 grants lock 320 to thread 310. Thread 310 is then able to access the contested resource. As long as there are no other threads waiting for lock 320, no further action is taken. Should another thread seek to acquire lock 320, that other thread must wait until thread 310 releases lock. When synchronization control 316 releases lock 320 from thread 310, lock 320 may be acquired by the other thread.

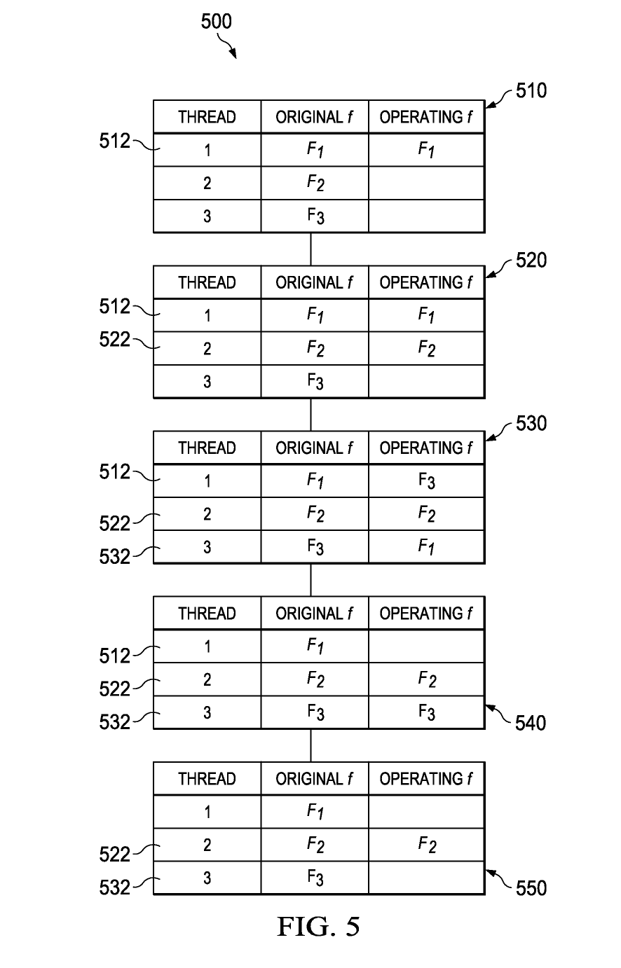

Referring now to FIG. 4, a first dataflow for lock acquisition by a second thread operating at a lower frequency within a multiprocessor system is shown according to an illustrative embodiment. Multiprocessor system 400 is multiprocessor system such as multiprocessor system 300 of FIG. 3.

Thread 410 executes on processor 412. Processor 412 operates at frequency 414. Frequency 414 is originally set to F₁. Synchronization control 416 tracks the frequency 414 of processor 412 in frequency tracking data structure 418. Thread 410 holds lock 420 for access to a contested resource, such as contested resource 222 of FIG. 2.

Thread 422 executes on processor 424. Processor 424 operates at frequency 426. Frequency 426 is originally set to F₂. In the illustrative embodiment, F₁ is greater than F₂. Synchronization control 416 tracks frequency 426 of processor 412 in frequency tracking data structure 418. Thread 422 seeks to acquire lock 420 for access to a contested resource, such as contested resource 222 of FIG. 2.

Synchronization control 416 then compares frequency 414 of processor 412, set at F₁, to frequency 426 of processor 424, set at F₂. In the illustrative embodiment, F₁ is greater than F₂. Therefore, synchronization control 416 does not alter frequency 414 of processor 412.

Because lock 420 is held by thread 410, thread 422 “spins” until the lock is available. In an illustrative embodiment, synchronization control 416 may set frequency 426 of processor 424 to F_{wait}. F_{wait} is a very low processor frequency with associated low power. F_{wait} is used by threads waiting for a spinlock. F_{wait} may be, for example, the same speed that an idle thread uses to run an idle loop on machines using idle loops. In another illustrative embodiment, processor 424 may continue to “spin” at the original frequency 426 of F₂.

When thread 410 is finished accessing the contested resource, such as contested resource 222 of FIG. 2, thread 410 releases lock 420. Synchronization 416 then ensures that frequency 414 is set to the original frequency F₁.

When thread 410 releases lock 420, the waiting thread with the highest original frequency is given control. In this illustrative embodiment, only thread 422 is waiting. Therefore, thread 422 acquires lock 420. In an illustrative embodiment, processor 424 is reset to original frequency 426 of F₂.

In another illustrative embodiment, the frequency 426 assigned to processor 424 is its original frequency F₂ plus the maximum additional speed allowed by the power transferred from any additional threads that are continuing to wait. That is, frequency 426 is set to the frequency:

$$F = {F}_{2} + {\sum }_{3}^{N} ( {F}_{N} - {F}_{wait} )$$

However, in the present illustrative embodiment, because thread 422 is the only thread waiting for lock 420, the frequency as determined by the above formula effectively resets frequency 426 of processor 424 is to F₂.

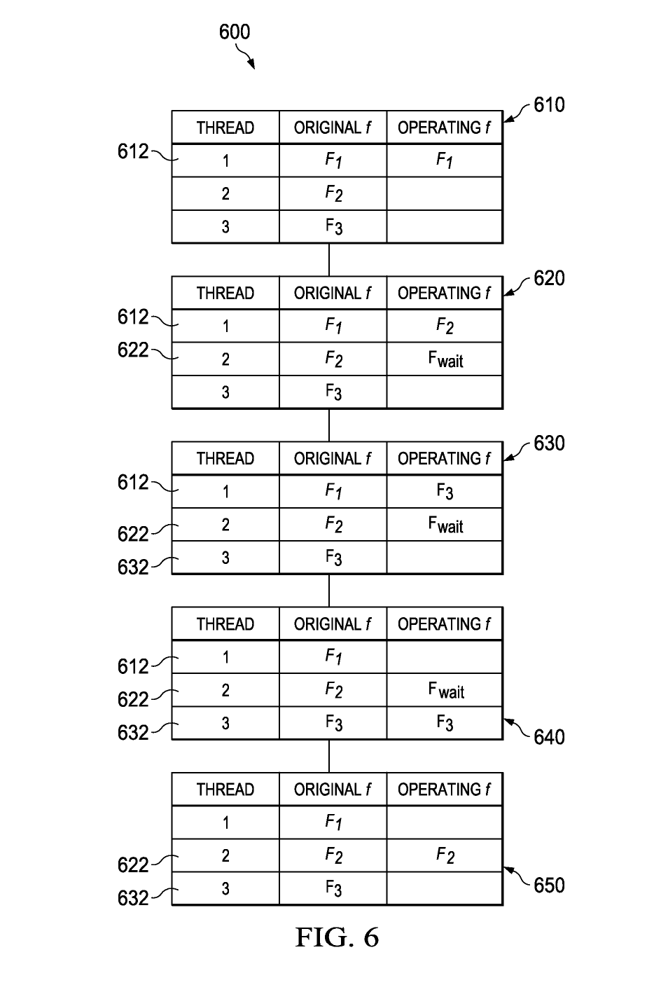

Referring now to FIG. 5, a series of frequency tracking data structures are shown for tracking frequencies of a plurality of processors executing threads requesting access to a lock is shown according to one illustrative embodiment. In the illustrative embodiment, the lock holder executes at the highest original frequency of the waiting threads. Other waiting threads spin at other original frequencies of the waiting threads. Each frequency tracking data structure of series 500 is a frequency tracking data structure such as frequency tracking data structure 418 of FIG. 4.

Frequency tracking data structure 510 indicates that a request to acquire a lock is received from thread 1 512. Thread 1 512 is a thread such as one of thread 410 or thread 422 of FIG. 4. The lock is granted to thread 1 512, and a synchronization control, such as synchronization control 418 of FIG. 4, records in frequency tracking data structure 510 the original frequency F₁ for the processor executing thread 512.

Frequency tracking data structure 520 is frequency tracking data structure 510 at a subsequent time. Thread 1 512 still holds the lock. Frequency tracking data structure 520 indicates that a second request to acquire the lock is received from thread 2 522. Because thread 1 512 already holds the lock, thread 2 522 must “spin,” waiting for thread 1 512 to release the lock.

A synchronization control, such as synchronization control 416 of FIG. 4, then compares the operating frequency of the processor executing thread 1 512, set at F₁, to the original frequency of the processor executing thread 2 522, set at F₂. In this illustrative embodiment, F₁ is greater than F₂. The synchronization control therefore allows the processor executing thread 1 512 to continue at the higher operating frequency F₁, while thread 2 522 spins on its processor at the lower operating frequency F₂.

Frequency tracking data structure 530 is frequency tracking data structure 520 at a subsequent time. Thread 1 512 still holds the lock. Frequency tracking data structure 530 indicates that a third request to acquire the lock is received from thread 3 532. Because thread 1 512 already holds the lock, thread 3 532 must “spin,” waiting for thread 1 512 to release the lock.

A synchronization control, such as synchronization control 416 of FIG. 4, then compares the operating frequency of the processor executing thread 1 512, set at F₁, to the original frequency of the processor executing thread 3 532, set at F₃. In this illustrative embodiment, F₃ is greater than F₁. The synchronization control sets the operating frequency of the processor executing thread 1 512 to F₃. Additionally, synchronization sets the operating frequency of the processor executing thread 3 532 to F₁, the operating frequency of the frequency of the processor executing thread 1 512 prior to thread 3 532 requesting the lock.

Frequency tracking data structure 540 is frequency tracking data structure 530 at a subsequent time. Thread 1 512 has released the lock. A synchronization control, such as synchronization control 416 of FIG. 4, resets the operating frequency for the processor executing thread 1 512 to its original frequency, F₁.

With multiple waiting threads, when thread 1 512 releases the lock, the waiting thread with the highest original frequency is given control. The speed assigned to it under the second embodiment is its previous speed.

In this illustrative embodiment, F₃ is greater than F₂. Therefore, thread 3 532 acquires the lock.

A synchronization control, such as synchronization control 416 of FIG. 4, then resets thread 3 532 to its original frequency, F₃. The synchronization control also resets threads 2 522 to its original frequency, F₂.

Frequency tracking data structure 550 is frequency tracking data structure 540 at a subsequent time. Thread 3 532 has released the lock. A synchronization control, such as synchronization control 416 of FIG. 4, ensures that the operating frequency for the processor executing thread 3 532 is reset to its original frequency, F₃.

Now, only thread 2 522 is waiting. Therefore, thread 2 522 acquires the lock. A synchronization control, such as synchronization control 416 of FIG. 4, ensures that the operating frequency for the processor executing thread 2 522 is reset to its original frequency, F₂.

Referring now to FIG. 6, a series of frequency tracking data structures are shown for tracking frequencies of a plurality of processors executing threads requesting access to a lock is shown according to one illustrative embodiment. In the illustrative embodiment, the lock holder executes at the highest original frequency of the waiting threads. Other waiting threads spin at a very low processor frequency with associated low power. Each frequency tracking data structure of series 600 is a frequency tracking data structure such as frequency tracking data structure 418 of FIG. 4.

Frequency tracking data structure 610 indicates that a request to acquire a lock is received from thread 1 612. Thread 1 612 is a thread such as one of thread 410 or thread 422 of FIG. 4. The lock is granted to thread 1 612, and a synchronization control, such as synchronization control 418 of FIG. 4, records in frequency tracking data structure 610 the original frequency F₁ for the processor executing thread 612.

Frequency tracking data structure 620 is frequency tracking data structure 610 at a subsequent time. Thread 1 612 still holds the lock. Frequency tracking data structure 620 indicates that a second request to acquire the lock is received from thread 2 622. Because thread 1 612 already holds the lock, thread 2 622 must “spin,” waiting for thread 1 612 to release the lock.

A synchronization control, such as synchronization control 416 of FIG. 4, then compares the operating frequency of the processor executing thread 1 612, set at F₁, to the original frequency of the processor executing thread 2 622, set at F₂. In this illustrative embodiment, F₂ is greater than F₁. The synchronization control sets the operating frequency of the processor executing thread 1 612 to F₂. Additionally, synchronization control sets the operating frequency of the processor executing thread 2 622 to F_{wait}. F_{wait} is a very low processor frequency with associated low power. F_{wait} is used by threads waiting for a spinlock. F_{wait} may be, for example, the same speed that an idle thread uses to run an idle loop on machines using idle loops.

Frequency tracking data structure 630 is frequency tracking data structure 620 at a subsequent time. Thread 1 612 still holds the lock. Frequency tracking data structure 630 indicates that a third request to acquire the lock is received from thread 3 632. Because thread 1 612 already holds the lock, thread 3 632 must “spin,” waiting for thread 1 612 to release the lock.

A synchronization control, such as synchronization control 416 of FIG. 4, then compares the operating frequency of the processor executing thread 1 612, set at F₂, to the original frequency of the processor executing thread 3 632, set at F₃. In this illustrative embodiment, F₂ is less than F₃, and also less than F₁. The synchronization control sets the operating frequency of the processor executing thread 1 612 to F₃. Additionally, synchronization control sets the operating frequency of the processor executing thread 3 632 to F_{wait}.

Frequency tracking data structure 640 is frequency tracking data structure 630 at a subsequent time. Thread 1 612 has released the lock. A synchronization control, such as synchronization control 416 of FIG. 4, resets the operating frequency for the processor executing thread 1 612 to its original frequency, F₁.

With multiple waiting threads, when thread 1 612 releases the lock, the waiting thread with the highest original frequency is given control. The speed assigned to it under the second embodiment is its previous speed.

In this illustrative embodiment, F₃ is greater than F₂. Therefore, thread 3 632 acquires the lock.

A synchronization control, such as synchronization control 416 of FIG. 4, then resets thread 3 632 to its original frequency, F₃. The synchronization control allows the processor executing thread 2 622 to continue to “spin” at the low power frequency F_{wait}.

Frequency tracking data structure 650 is frequency tracking data structure 640 at a subsequent time. Thread 3 632 has released the lock. A synchronization control, such as synchronization control 416 of FIG. 4, ensures that the operating frequency for the processor executing thread 3 632 is reset to its original frequency, F₂.

Now, only thread 2 622 is waiting. Therefore, thread 2 622 acquires the lock. A synchronization control, such as synchronization control 416 of FIG. 4, ensures that the operating frequency for the processor executing thread 2 622 is reset to its original frequency, F₂.

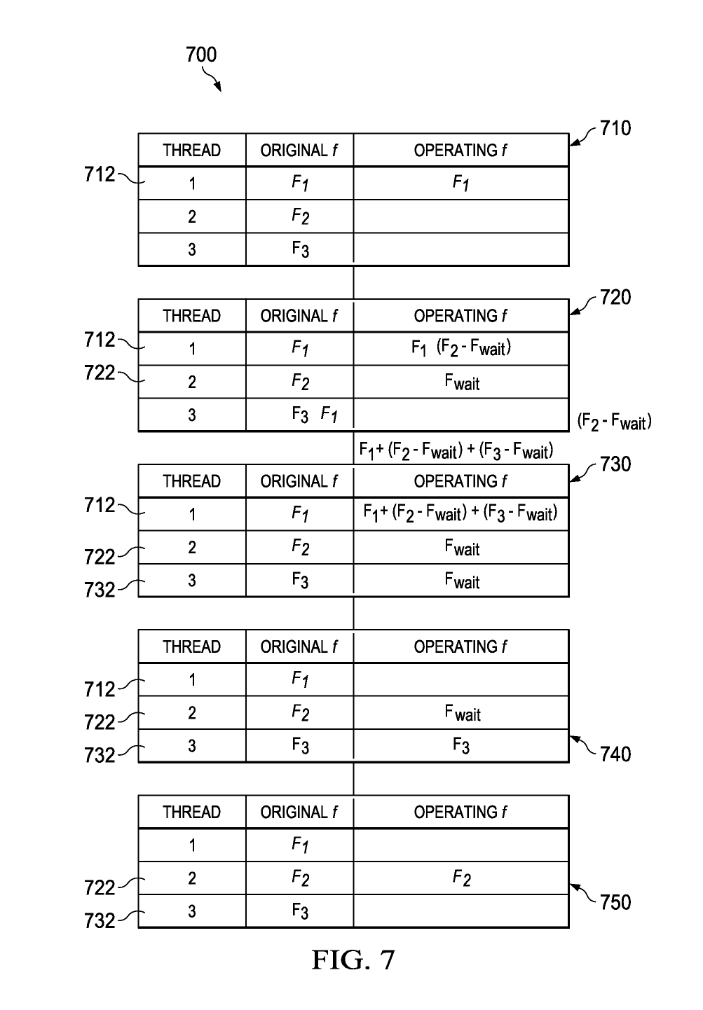

Referring now to FIG. 7, a series of frequency tracking data structures are shown for tracking frequencies of a plurality of processors executing threads requesting access to a lock is shown according to one illustrative embodiment. In the illustrative embodiment, the lock holder executes at the highest original frequency of the waiting threads. Other waiting threads spin at a very low processor frequency with associated low power. Each frequency tracking data structure of series 700 is a frequency tracking data structure such as frequency tracking data structure 418 of FIG. 4.

Frequency tracking data structure 710 indicates that a request to acquire a lock is received from thread 1 712. Thread 1 712 is a thread such as one of thread 410 or thread 524222 of FIG. 4. The lock is granted to thread 1 712, and a synchronization control, such as synchronization control 418 of FIG. 4, records in frequency tracking data structure 710 the original frequency F₁ for the processor executing thread 1 712.

Frequency tracking data structure 720 is frequency tracking data structure 710 at a subsequent time. Thread 1 712 still holds the lock. Frequency tracking data structure 720 indicates that a second request to acquire the lock is received from thread 2 722. Because thread 1 712 already holds the lock, thread 2 722 must “spin,” waiting for thread 1 712 to release the lock.

A synchronization control, such as synchronization control 416 of FIG. 4, then compares the operating frequency of the processor executing thread 1 712, set at F₁, to the original frequency of the processor executing thread 2 722, set at F₂. In this illustrative embodiment, F₁ is greater than F₂.

Successive speed boost and power transfers can be realized as the number of waiting threads increases. When a new waiting thread arrives, if the new thread is operating at a frequency that is greater than the low power frequency, the waiting thread goes to the wait speed. Thread 1712 then inherits a frequency boost of the newly arriving thread.

The synchronization control sets the operating frequency of the processor executing thread 2 722, set at F_{wait}. The synchronization control sets the operating frequency of the processor executing thread 1 712 to its original frequency F₁ plus the maximum additional speed allowed by the power transferred from any additional threads that are continuing to wait. That is, the operating frequency for thread 1 712 is set to the frequency:

$$F = {F}_{2} + {\sum }_{3}^{N} ( {F}_{N} - {F}_{wait} )$$

In the present illustrative embodiment, the operating frequency of the processor executing thread 1 712 is set to:

F=F₁+(F₂−F_{wait})

Frequency tracking data structure 730 is frequency tracking data structure 720 at a subsequent time. Thread 1 712 still holds the lock. Frequency tracking data structure 730 indicates that a third request to acquire the lock is received from thread 3 732. Because thread 1 712 already holds the lock, thread 3 732 must “spin,” waiting for thread 1 712 to release the lock.

A synchronization control, such as synchronization control 416 of FIG. 4, then compares the operating frequency of the processor executing thread 1 712, set at F₁+(F₂−F_{wait}), to the original frequency of the processor executing thread 3 732, set at F₃. In this illustration F₁+(F₂−F_{wait}) is greater than F₃.

The synchronization control sets the operating frequency of the processor executing thread 3 732, set at F_{wait}. The synchronization control sets the operating frequency of the processor executing thread 1 712 to its original frequency F₁ plus the maximum additional speed allowed by the power transferred from any additional threads that are continuing to wait. That is, the operating frequency for thread 1 712 is set to:

$$F = {F}_{1} + {\sum }_{3}^{N} ( {F}_{N} - {F}_{wait} )$$

In the present illustrative embodiment, the operating frequency of the processor executing thread 1 712 is set to:

F=F₁+(F₂−F_{wait})+(F₃−F_{wait})

Frequency tracking data structure 740 is frequency tracking data structure 730 at a subsequent time. Thread 1 712 has released the lock. A synchronization control, such as synchronization control 416 of FIG. 4, resets the operating frequency for the processor executing thread 1 712 to its original frequency, F₁.

With multiple waiting threads, when thread 1 712 releases the lock, the waiting thread with the highest original frequency is given control. The speed assigned to it under the second embodiment is its previous speed plus the maximum additional speed allowed by the power transferred from the threads that are continuing to wait.

In this illustrative embodiment, F₂ is greater than F₃. Therefore, thread 2 722 acquires the lock.

The synchronization control sets the operating frequency of the processor executing thread 3 732, set at F_{wait}. The synchronization control sets the operating frequency of the processor executing thread 2 722 to its original frequency F₂ plus the maximum additional speed allowed by the power transferred from any additional threads that are continuing to wait. That is, the operating frequency for thread 2 722 is set to the frequency:

$$F = {F}_{2} + {\sum }_{3}^{N} ( {F}_{N} - {F}_{wait} )$$

In the present illustrative embodiment, the operating frequency of the processor executing thread 2 722 is set to:

F=F₂+(F₃−F_{wait})

Frequency tracking data structure 750 is frequency tracking data structure 740 at a subsequent time. Thread 2 722 has released the lock. A synchronization control, such as synchronization control 416 of FIG. 4, ensures that the operating frequency for the processor executing thread 2 722 is reset to its original frequency, F₂. Now, only thread 3 732 is waiting. Therefore, thread 3 732 acquires the lock. A synchronization control, such as synchronization control 416 of FIG. 4, ensures that the operating frequency for the processor executing thread 3 732 is reset to its original frequency, F₃.

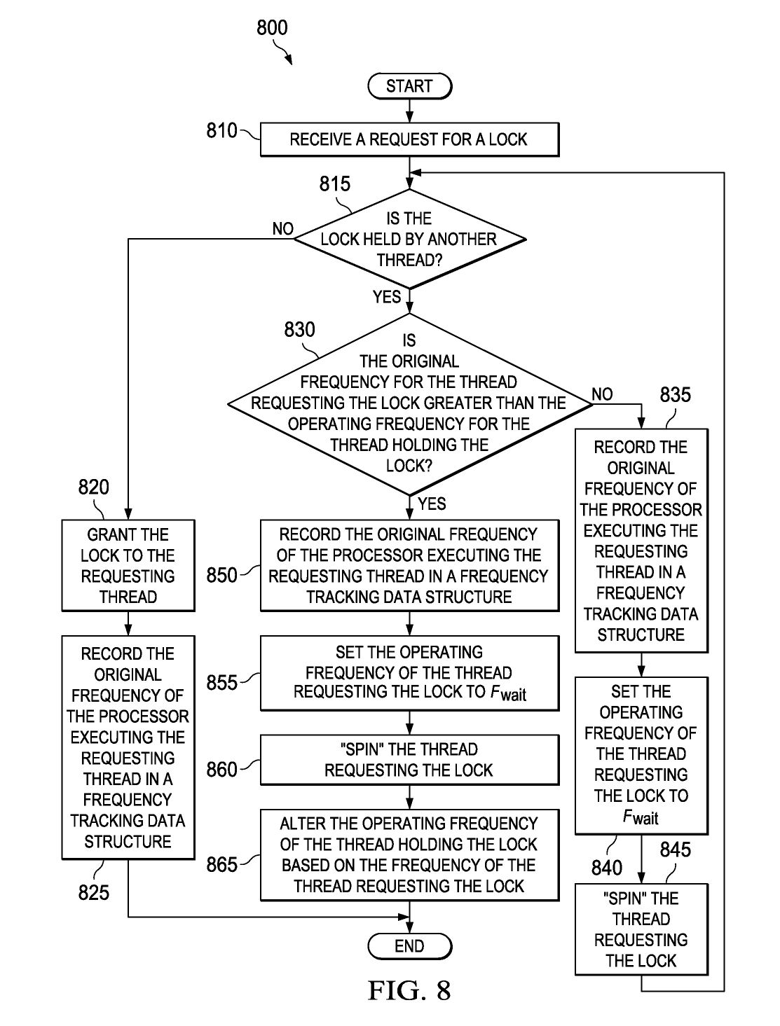

Referring now to FIG. 8, a flowchart for dynamically reallocating power between processors of a multiprocessor system when a lock is requested is shown according to an illustrative embodiment. Process 800 is a software process, executing on a software component, such as synchronization control 226 of FIG. 2.

Process 800 begins by receiving a request for a lock (step 810). The lock may be, for example, lock 224 of FIG. 2. The request for a lock is received from a thread, such as one of thread 218 and thread 220 of FIG. 2 that seeks to access a contested resource, such as contested resource 222 of FIG. 2.

Responsive to receiving the request for the lock, process 800 determines whether the lock is held by another thread (step 815). If another thread is currently utilizing the contested resource, then that thread will hold the lock. However, if no other thread is currently utilizing the contested resource, then the lock is free, and can be granted to the requesting thread.

Responsive to determining that the lock is not held by another thread (“no” at step 815), process 800 grants the lock to the requesting thread (step 820). The requesting thread can then access the contested resource. Process 800 records the original frequency of the processor executing the requesting thread in a frequency tracking data structure (step 825), and the process terminates thereafter. The frequency tracking data structure may be, for example, frequency tracking data structure 228 of FIG. 2.

Returning now to step 815, responsive to determining that the lock is held by another thread (“yes” at step 815), process 800 determines whether the original frequency for the thread requesting the lock is greater than the operating frequency for the thread holding the lock (step 830). Responsive to determining that the original frequency of the processor for the thread requesting the lock is not greater than the operating frequency for the thread holding the lock (“no” at step 830), process 800 records the original frequency of the processor executing the requesting thread in a frequency tracking data structure (step 835). Process 800 sets the operating frequency of the processor for the thread requesting the lock to F_{wait} (step 840), and begins to “spin” the thread requesting the lock (step 845). After a certain number of cycles, process 800 iterates back to step 815 to determine whether the lock has become available.

Returning now to step 830, responsive to determining that the original frequency for the thread requesting the lock is greater than the operating frequency of the processor for the thread holding the lock (“yes” at step 830), process 800 records the original frequency of the processor executing the requesting thread in a frequency tracking data structure (step 850). Process 800 sets the operating frequency of the processor for the thread requesting the lock to F_{wait} (step 855), and begins to “spin” the thread requesting the lock (step 860). Process 800 alters the operating frequency for the thread holding the lock based on the frequency of the processor for thread requesting the lock (step 865), with the process terminating thereafter.

In one illustrative embodiment, process 800 alters the operating frequency for the thread holding the lock by simply substituting the operating frequency of the thread holding the lock for the operating frequency of the processor for thread requesting the lock. In another illustrative embodiment, process 800 alters the operating frequency for thread holding the lock by augmenting the operating frequency of the thread holding the lock by an amount equal to the difference between the operating frequency of the processor for thread requesting the lock and the frequency of the low power state of the processor for the requesting thread that is now “spinning.”

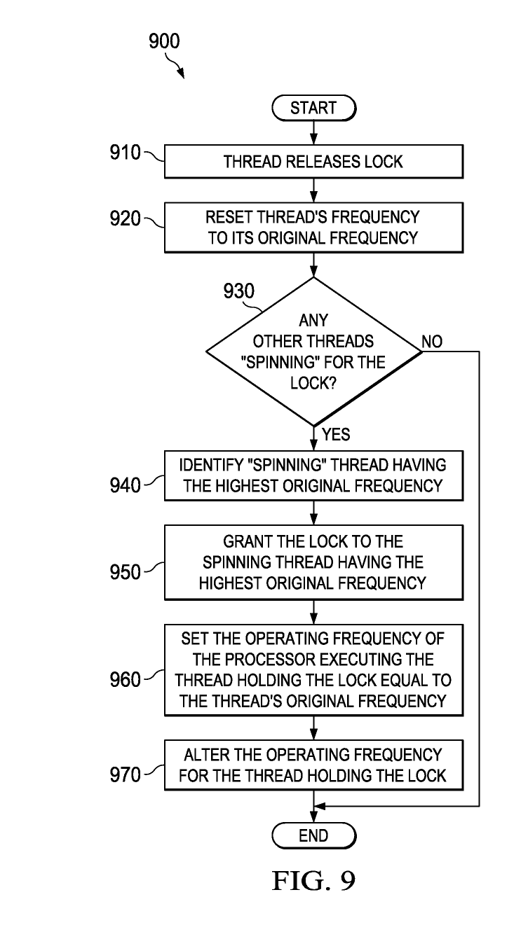

Referring now to FIG. 9, a flowchart for dynamically reallocating power between processors of a multiprocessor system when a lock is released is shown according to an illustrative embodiment. Process 900 is a software process, executing on a software component, such as synchronization control 326 of FIG. 3.

Process 900 begins when a thread releases a lock (step 910). The lock may be, for example, lock 320 of FIG. 3. The thread is a thread such as thread 310 of FIG. 3 that has controlled a contested resource, such as contested resource 222 of FIG. 2. The thread may be operating at an altered frequency.

Process 900 then resets the thread's frequency to its original frequency (step 920). The original frequency can be found in a frequency tracking data structure. The frequency tracking data structure may be, for example, frequency tracking data structure 318 of FIG. 3.

Process 900 then determines if there are any other threads “spinning” for the lock (step 930). If no other threads are “spinning” for the lock (“no” at step 930), the process terminates. If process 900 determines that additional threads are “spinning” for the lock (“yes” at step 930), then process 900 identifies the “spinning” thread having the highest original frequency (step 940).

Process 900 then grants the lock to the spinning thread having the highest original frequency (step 950). That thread can then access the contested resource. Process 900 sets the operating frequency of the processor executing the thread holding the lock equal to the thread's original frequency (step 960). The original frequency can be found in a frequency tracking data structure. The frequency tracking data structure may be, for example, frequency tracking data structure 318 of FIG. 3.

In one illustrative embodiment, process 900 can further alter the operating frequency of the processor for thread holding the lock by augmenting the operating frequency of the thread holding the lock by an amount equal to the difference between the operating frequency of the processor for any remaining spinning threads and the frequency of a low power state of the processor for the requesting thread that is now “spinning.” (step 970). Responsive to resetting the operating frequency for the thread now holding the lock, process 900 terminates.

Thus, the illustrative embodiments herein provide a computer implemented method for allocating power between processors in a multiprocessor system. A request to acquire a lock is received from a first thread executing on a first processor. Responsive to receiving the request to acquire a lock, determination is made as to whether a second thread has acquired the lock. Responsive to determining that the second thread has acquired the lock, an original frequency of the first thread executing on the first processor and identifying an operating frequency of the second thread executing on the second processor is identified. The operating frequency of the second thread executing on the second processor is then altered based on the original frequency of the first thread executing on the first processor.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by, or in connection with, the instruction execution system, apparatus, or device.

The medium can be an electronic, magnetic, optical, electromagnetic, infrared, semiconductor system (apparatus or device), or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output, or I/O devices (including but not limited to keyboards, displays, pointing devices, etc.), can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for allocating power between processors in a multiprocessor system, the method comprising:
receiving a request to acquire a lock from a first thread executing on a first processor;
responsive to receiving the request to acquire a lock, determining whether a second thread has acquired the lock;
responsive to determining that the second thread has acquired the lock, identifying an original frequency of the first thread executing on the first processor and identifying an operating frequency of the second thread executing on the second processor; and
altering the operating frequency of the second thread executing on the second processor based on the original frequency of the first thread executing on the first processor.

2. The computer implemented method of claim 1, further comprising:
setting an operating frequency of the first thread executing on the first processor equal to a low processor frequency associated with a low power setting, wherein the first thread is waiting to acquire the lock.

3. The computer implemented method of claim 1, further comprising:
determining whether the original frequency of the first thread executing on the first processor is greater than the operating frequency of the second thread executing on the second processor;
responsive to determining that the original frequency of the first thread is greater than the operating frequency of the second thread, altering the operating frequency of the second thread executing on the second processor based on the original frequency of the first thread executing on the first processor, wherein altering the operating frequency of the second thread further comprises:
setting the operating frequency of the second thread executing on the second processor equal to the original frequency of the first thread executing on the first processor.

4. The computer implemented method of claim 2, wherein the step of altering the operating frequency of the second thread executing on the second processor based on the original frequency of the first thread executing on the first processor further comprises:
augmenting the operating frequency of the second thread executing on the second processor by an amount equal to the difference between the original frequency of the first thread and the operating frequency of the first thread.

5. The computer implemented method of claim 4, further comprising:
receiving a second request to acquire the lock from a third thread executing on a third processor;
setting an operating frequency of the third thread executing on the third processor to the low processor frequency associated with the low power setting;
determining whether an original frequency of the third thread executing on the third processor is greater than the operating frequency of the second thread executing on the second processor;
responsive to determining that the original frequency of the third thread is greater than the operating frequency of the second thread, augmenting the operating frequency of the second thread executing on the second processor by an amount equal to the difference between an original frequency of the third thread and the operating frequency of the first thread.

6. The computer implemented method of claim 5, wherein the operating frequency of the second thread executing on the second processor is determined by the formula:
$$F = {F}_{1} + {\sum }_{2}^{N} ( {F}_{N} - Fwait )$$
wherein:
F is the operating frequency of the second thread executing on the second processor;
F₁ is the original frequency of the second thread executing on the second processor;
F_{N} is the original frequency of other threads waiting to acquire the lock, wherein the other threads comprise the first thread and the third thread; and
F_{wait} is the low processor frequency associated with the low power setting.

7. The computer implemented method of claim 2, further comprising:
releasing the lock by the second thread executing on the second processor;
setting the operating frequency of the second thread executing on the second processor equal to an original frequency of the second thread executing on the second processor; and
setting the operating frequency of the first thread executing on the first processor equal to the original frequency of the first thread executing on the first processor.

8. The computer implemented method of claim 5 further comprising:
releasing the lock by the second thread executing on the second processor;
determining whether the original frequency of the first thread executing on the first processor is greater than the original frequency of the third thread executing on the third processor;
responsive to determining that the original frequency of the first thread is greater than the original frequency of the third thread, granting the lock to the first thread; and
altering the operating frequency of the first thread executing on the first processor based on the original frequency of the third thread executing on the third processor.

9. A computer storage type medium having computer usable instructions encoded thereon for allocating power between processors in a multiprocessor system, the computer usable instructions comprising:
instructions for receiving a request to acquire a lock from a first thread executing on a first processor;
instructions, responsive to receiving the request to acquire a lock, for determining whether a second thread has acquired the lock;
instructions, responsive to determining that the second thread has acquired the lock, for identifying an original frequency of the first thread executing on the first processor and identifying an operating frequency of the second thread executing on the second processor; and
instructions for altering the operating frequency of the second thread executing on the second processor based on the original frequency of the first thread executing on the first processor.

10. The computer storage type medium of claim 9, further comprising:
instructions for setting an operating frequency of the first thread executing on the first processor equal to a low processor frequency associated with a low power setting, wherein the first thread is waiting to acquire the lock.

11. The computer storage type medium of claim 9, the computer usable instructions further comprising:
instructions for determining whether the original frequency of the first thread executing on the first processor is greater than the operating frequency of the second thread executing on the second processor;
instructions, responsive to determining that the original frequency of the first thread is greater than the operating frequency of the second thread, for altering the operating frequency of the second thread executing on the second processor based on the original frequency of the first thread executing on the first processor, wherein altering the operating frequency of the second thread further comprises:
instructions for setting the operating frequency of the second thread executing on the second processor equal to the original frequency of the first thread executing on the first processor.

12. The computer storage type medium of claim 10, wherein the instructions for altering the operating frequency of the second thread executing on the second processor based on the original frequency of the first thread executing on the first processor further comprises:
instructions for augmenting the operating frequency of the second thread executing on the second processor by an amount equal to the difference between the original frequency of the first thread and the operating frequency of the first thread.

13. The computer storage type medium of claim 12, the computer usable instructions further comprising:
instructions for receiving a second request to acquire the lock from a third thread executing on a third processor;
instructions for setting an operating frequency of the third thread executing on the third processor to the low processor frequency associated with the low power setting;
instructions for determining whether an original frequency of the third thread executing on the third processor is greater than the operating frequency of the second thread executing on the second processor;
instructions, responsive to determining that the original frequency of the third thread is greater than the operating frequency of the second thread, for augmenting the operating frequency of the second thread executing on the second processor by an amount equal to the difference between an original frequency of the third thread and the operating frequency of the first thread.

14. The computer storage type medium of claim 13, wherein the operating frequency of the second thread executing on the second processor is determined by the formula:
$$F = {F}_{1} + {\sum }_{2}^{N} ( {F}_{N} - Fwait )$$
wherein:
F is the operating frequency of the second thread executing on the second processor;
F₁ is the original frequency of the second thread executing on the second processor;
F_{N} is the original frequency of other threads waiting to acquire the lock, wherein the other threads comprise the first thread and the third thread; and
F_{wait} is the low processor frequency associated with the low power setting.

15. The computer storage type medium of claim 9, the computer usable instructions further comprising:
instructions for releasing the lock by the second thread executing on the second processor;
instructions for setting the operating frequency of the second thread executing on the second processor equal to an original frequency of the second thread executing on the second processor; and
instructions for setting the operating frequency of the first thread executing on the first processor equal to the original frequency of the first thread executing on the first processor.

16. The computer storage type medium of claim 13, the computer usable instructions further comprising:
instructions for releasing the lock by the second thread executing on the second processor;
instructions for determining whether the original frequency of the first thread executing on the first processor is greater than the original frequency of the third thread executing on the third processor;
instructions, responsive to determining that the original frequency of the first thread is greater than the original frequency of the third thread, for granting the lock to the first thread; and
instructions for altering the operating frequency of the first thread executing on the first processor based on the original frequency of the third thread executing on the third processor.

17. A data processing system comprising:
a storage having computer usable instructions encoded thereon for allocating power between processors in a multiprocessor system;
a bus connecting the storage to a processor; and
a processor, wherein the processor executes the computer usable instructions: to receive a request to acquire a lock from a first thread executing on a first processor;
responsive to receiving the request to acquire a lock, to determine whether a second thread has acquired the lock; responsive to determining that the second thread has acquired the lock, to identify an original frequency of the first thread executing on the first processor and identifying an operating frequency of the second thread executing on the second processor; and to alter the operating frequency of the second thread executing on the second processor based on the original frequency of the first thread executing on the first processor.

18. The data processing system of claim 17, wherein the processor further executes the computer usable instructions:
to set an operating frequency of the first thread executing on the first processor equal to a low processor frequency associated with a low power setting, wherein the first thread is waiting to acquire the lock.

19. The data processing system of claim 17, wherein the processor further executes the computer usable instructions:
to determine whether the original frequency of the first thread executing on the first processor is greater than the operating frequency of the second thread executing on the second processor; responsive to determining that the original frequency of the first thread is greater than the operating frequency of the second thread, to alter the operating frequency of the second thread executing on the second processor based on the original frequency of the first thread executing on the first processor, wherein the processor further executes the computer usable instructions to alter the operating frequency of the second thread further comprises the processor further executes the computer usable instructions to set the operating frequency of the second thread executing on the second processor equal to the original frequency of the first thread executing on the first processor.

20. The data processing system of claim 18, wherein the processor further executes the computer usable instructions to alter the operating frequency of the second thread executing on the second processor based on the original frequency of the first thread executing on the first processor further comprises the processor further executes the computer usable instructions to augment the operating frequency of the second thread executing on the second processor by an amount equal to the difference between the original frequency of the first thread and the operating frequency of the first thread.

21. The data processing system of claim 20, wherein the processor further executes the computer usable instructions:
to receive a second request to acquire the lock from a third thread executing on a third processor; to set an operating frequency of the third thread executing on the third processor to the low processor frequency associated with the low power setting; to determine whether an original frequency of the third thread executing on the third processor is greater than the operating frequency of the second thread executing on the second processor; and responsive to determining that the original frequency of the third thread is greater than the operating frequency of the second thread, to augment the operating frequency of the second thread executing on the second processor by an amount equal to the difference between an original frequency of the third thread and the operating frequency of the first thread.

22. The data processing system of claim 18, wherein the processor further executes the computer usable instructions:
to release the lock by the second thread executing on the second processor; to set the operating frequency of the second thread executing on the second processor equal to an original frequency of the second thread executing on the second processor; and to set the operating frequency of the first thread executing on the first processor equal to the original frequency of the first thread executing on the first processor.

23. The data processing system of claim 21, wherein the processor further executes the computer usable instructions:
to the lock by the second thread executing on the second processor; to determine whether the original frequency of the first thread executing on the first processor is greater than the original frequency of the third thread executing on the third processor; responsive to determining that the original frequency of the first thread is greater than the original frequency of the third thread, to grant the lock to the first thread; and to alter the operating frequency of the first thread executing on the first processor based on the original frequency of the third thread executing on the third processor.
